(19) United States
(12) Patent Application Publication
(10) Pub. No.: US 2026/0322720 A1
(43) Pub. Date: Oct. 15, 2026

(54) DETECTING DEVICE, DETECTING METHOD, AND DETECTING PROGRAM

(71) Applicant: NTT, Inc., Tokyo (JP)

(72) Inventors: Yuki YAMANAKA, Musashino-shi, Tokyo (JP); Takuya MINAMI, Musashino-shi, Tokyo (JP); Tomokatsu TAKAHASHI, Musashino-shi, Tokyo (JP)

(73) Assignee: NTT, Inc., Tokyo (JP)

(21) Appl. No.: 19/483,634

(22) PCT Filed: Jul. 11, 2023
(86) PCT No.: PCT/JP2023/025542

§ 371 Date: Nov. 12, 2025

(30) Foreign Application Priority Data
May 25, 2023 (WO) PCT/JP2023/019586

(51) Int. Cl. H04L 43/0823; G06F 40/40

(52) U.S. Cl. CPC H04L 43/0823; G06F 40/40

(57) ABSTRACT

A detection device includes a memory and processing circuitry configured to extract a predetermined number of pieces of similar normal packet data with a relatively high similarity to evaluation target packet data from a plurality of pieces of normal packet data on a basis of a natural language processing model, and detect whether or not the evaluation target packet data is abnormal on the basis of an anomaly score calculated by comparing a predetermined number of pieces of the similar normal packet data extracted with the evaluation target packet data.

### TECHNICAL FIELD

The present invention relates to a detection device, a detection method, and a detection program.

### BACKGROUND ART

Abnormality detection systems and intrusion detection systems (Operational Technology-Intrusion Detection System (OT-IDS)) for communication used in industrial and building system network control systems have attracted attention. In communication in a control system, for example, even when the set value of the temperature changes by just one digit, a serious accident may occur, In other words, in the communication in the control system, even when the communication content (payload) differs by one byte, a serious accident may occur.

Therefore, in the abnormality detection systems for industrial and building system network control systems, detailed analysis of the payload content is essential. That is, the abnormality detection system needs to detect an unauthorized rewriting of one byte in the payload without missing it.

Furthermore, various protocols are used in industrial and building system networks. Therefore, an abnormality detection system is required to be able to analyze the payload content for the general-purpose protocol.

Here, as an abnormality detection method, there is a method of extracting information from a payload of an arbitrary protocol and detecting an abnormality by applying a natural language processing technology such as Bidirectional Encoder Representations from Transformers (BERT) to packet analysis (Patent Literature 1).

### CITATION LIST

### Patent Literature

Patent Literature 1: International Publication Pamphlet No. WO 2022/059209 A

### Non Patent Literature

Non Patent Literature 1: Yutian Chen, Max Welling, Alex Smola, “Super-Samples from Kernel Herding”, [retrieved on Apr. 26, 2023], the Internet, <URL:https://arxiv.org/ftp/arxiv/papers/1203/1203.3472.pdf>

Non Patent Literature 2: Tianyi Zhang, Varsha Kishore, Felix Wu, Kilian Q. Weinberger, and Yoav Artzi, “BERTSCORE: EVALUATING TEXT GENERATION WITH BERT”, [retrieved on Apr. 26, 2023], the Internet, <URL: https://arxiv.org/abs/1904.09675.pdf>

### SUMMARY OF INVENTION

### Technical Problem

However, in the method described in Patent Literature 1, since the averaging processing of the packet direction is performed, the detection accuracy may deteriorate for a protocol having a long packet length. Furthermore, in the method described in Patent Literature 1, there is a problem that a false positive occurs in a case where a time stamp, a serial number portion, and the like are included in a packet and the time stamp, the serial number portion, and the like are not comprehensively included in training data.

The present invention has been made in view of the above-described problems, and an object thereof is to provide a detection device, a detection method, and a detection program capable of detecting an abnormality occurring in the content of a packet with high accuracy for a protocol having a long packet length.

### Solution to Problem

In order to solve the above problem and achieve the object, a detection device includes: an extraction unit that extracts a predetermined number of pieces of similar normal packet data with a relatively high similarity to evaluation target packet data from a plurality of pieces of normal packet data on a basis of a natural language processing model; and a detection unit that detects whether or not the evaluation target packet data is abnormal on the basis of an anomaly score calculated by comparing a predetermined number of pieces of the similar normal packet data extracted by the extraction unit with the evaluation target packet data.

### Advantageous Effects of Invention

According to the present invention, it is possible to detect an abnormality occurring in contents of a packet with high accuracy for a protocol having a long packet length.

### BRIEF DESCRIPTION OF DRAWINGS

FIG. 1 is a diagram illustrating an example of a configuration of a detection system according to a first embodiment.

FIG. 2 is a diagram illustrating an example of a configuration of a training device illustrated in FIG. 1.

FIG. 3 is a flowchart for describing a procedure of training processing executed by the training device illustrated in FIG. 2.

FIG. 4 is a diagram illustrating an example of a configuration of a detection device illustrated in FIG. 1.

FIG. 5 is a flowchart for describing a flow of processing of the detection device illustrated in FIG. 4.

FIG. 6 is a diagram for describing processing of a detection unit illustrated in FIG. 4.

FIG. 7 is a diagram for describing processing of the detection unit illustrated in FIG. 4.

FIG. 8 is a diagram describing first calculation processing.

FIG. 9 is a flowchart illustrating a procedure of detection processing according to the first embodiment,

FIG. 10 is a flowchart illustrating a procedure of first calculation processing illustrated in FIG. 9.

FIG. 11 is a flowchart illustrating a procedure of second calculation processing illustrated in FIG. 9.

FIG. 12 is a diagram illustrating a result of an evaluation experiment.

FIG. 13 is a diagram illustrating a result of an evaluation experiment.

FIG. 14 is a diagram illustrating an example of a configuration of a detection system according to a second embodiment.

FIG. 15 is a diagram illustrating an example of a configuration of a training device illustrated in FIG. 14.

FIG. 16 is a flowchart for describing a procedure of training processing executed by the training device illustrated in FIG. 15.

FIG. 17 is a diagram illustrating an example of a configuration of a detection device illustrated in FIG. 14.

FIG. 18 is a flowchart for describing a flow of processing of the detection device illustrated in FIG. 17.

FIG. 19 is a flowchart illustrating a procedure of detection processing according to the second embodiment.

FIG. 20 is a diagram illustrating an example of a computer in which a training device and a detection device are implemented by executing a program.

### DESCRIPTION OF EMBODIMENTS

Hereinafter, embodiments of a detection device, a detection method, and a detection program according to the present application will be described in detail with reference to the drawings. Note that the present invention is not limited to the embodiments to be described below.

[First embodiment] In a first embodiment, a detection device that detects abnormality of communication data (payload) will be described.

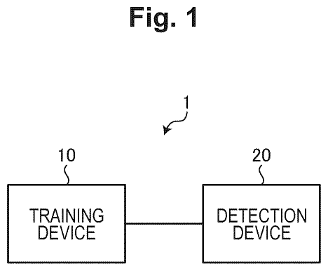

The detection device according to the first embodiment extracts data similar to the evaluation target packet data (similar normal packet data) from the normal communication data using natural language processing with Bidirectional Encoder Representations from Transformers (BERT). Then, the detection device according to the first embodiment calculates an anomaly score indicating a difference between the extracted similar normal packet data and the evaluation target packet data, and detects that the evaluation target packet data is abnormal and outputs an alert in a case where the anomaly score exceeds a predetermined threshold.

[Detection system] Next, a detection system according to the first embodiment will be described. FIG. 1 is a diagram illustrating an example of a configuration of the detection system according to the first embodiment.

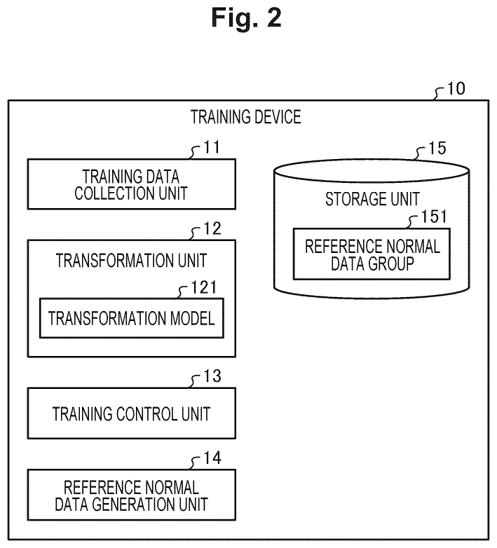

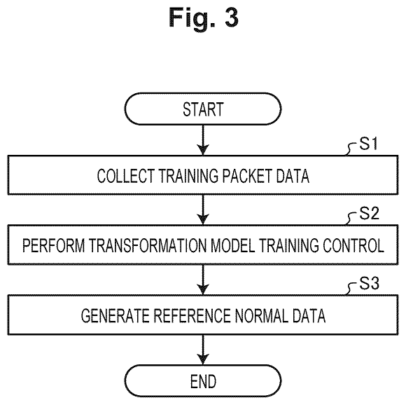

As illustrated in FIG. 1, a detection system 1 includes a training device 10 that executes training of a natural language processing model used by a detection device 20 and the detection device 20 that detects abnormality of communication data (payload) using the natural language processing model for which the training has been executed by the training device 10.

[Training device] FIG. 2 is a diagram illustrating an example of a configuration of the training device 10 illustrated in FIG. 1. FIG. 3 is a flowchart for describing a procedure of training processing executed by the training device 10 illustrated in FIG. 2.

The training device 10 is a device implemented by, for example, loading a predetermined program into a computer including a read only memory (ROM), a random access memory (RAM), a central processing unit (CPU), and the like, and executing the predetermined program by the CPU. Furthermore, the training device 10 includes a communication interface that transmits and receives various types of information to and from other devices connected via a network or the like.

The training device 10 includes a training data collection unit 11, a transformation unit 12 including a transformation model 121, a training control unit 13, a reference normal data generation unit 14, and a storage unit 15.

The training data collection unit 11 collects training packet data of the transformation model 121 (step S1 in FIG. 3).

The training control unit 13 performs transformation model training control for training the transformation model 121 to learn a packet transformation rule using the training packet data (step S2 in FIG. 3). The model parameters of the transformation model 121 optimized in step S2 are applied to a transformation model 231 (to be described later) of the detection device 20.

The transformation unit 12 transforms packet data into vector data using the transformation model 121. The vector data is data in which each byte of packet data is associated with each vector representing a characteristic of a value of each byte. A training control unit 154 trains the transformation model 121 to learn a value of each byte of the training packet data.

The transformation model 121 is, for example, a natural language processing model using BERT. The transformation model 121 transforms a value of each byte of each communication packet, which is the training packet data, into a 784-dimensional vector. In step S2 of FIG. 3, the transformation model 121 performs learning of a rule of transformation into vector data in which the position of each byte of the communication packet is associated with the 784-dimensional vector transformed from the byte.

Note that the training control unit 13 may perform control such that the preliminary training of the characteristic of the value of each byte in the training packet data is executed by solving an auxiliary task such as a masked language model (MLM) or next sentence prediction (NSP). The MLM predicts the values of these missing bytes in packets in which a plurality of bytes are missing. The NSP determines whether or not two pieces of packet data are consecutive packets. The training control unit 13 specifies validity of data in a packet and validity of consecutive packets by these auxiliary tasks, and generates a model that specifies training packet data. The auxiliary task described herein is an example, and the training control unit 13 may perform control such that the training is performed by solving other auxiliary tasks.

Furthermore, the reference normal data generation unit 14 generates a reference normal data group 151 using the training packet data (step S3 in FIG. 3). The reference normal data generation unit 14 sets a packet data group sampled from the training packet data as the reference normal data group 151.

At this time, the reference normal data generation unit 14 performs sampling, for example, using a sampling method such as kernel herding. In this case, random sampling is not performed in order to suppress occurrence of performance deterioration. Note that although it is desirable to perform sampling from the viewpoint of the processing speed, all pieces of training packet data may be used as the reference normal data group 151. Furthermore, as the number of pieces of the reference normal packet data of the reference normal data group 151 increases, the detection accuracy of the detection device 20 to be described later increases.

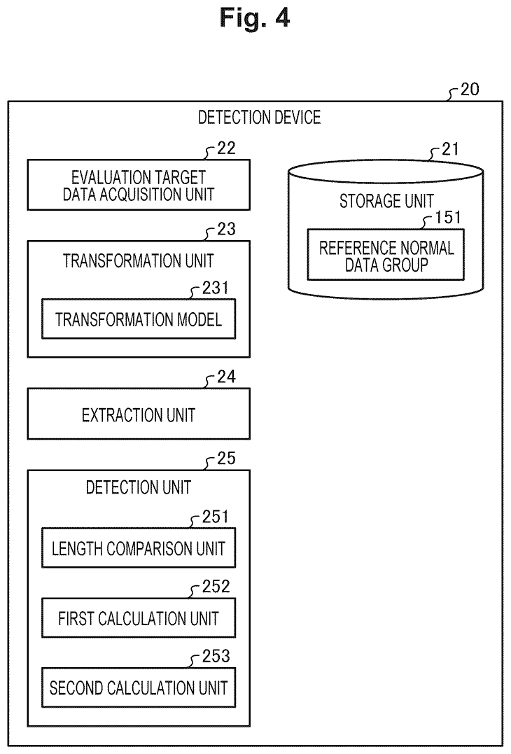

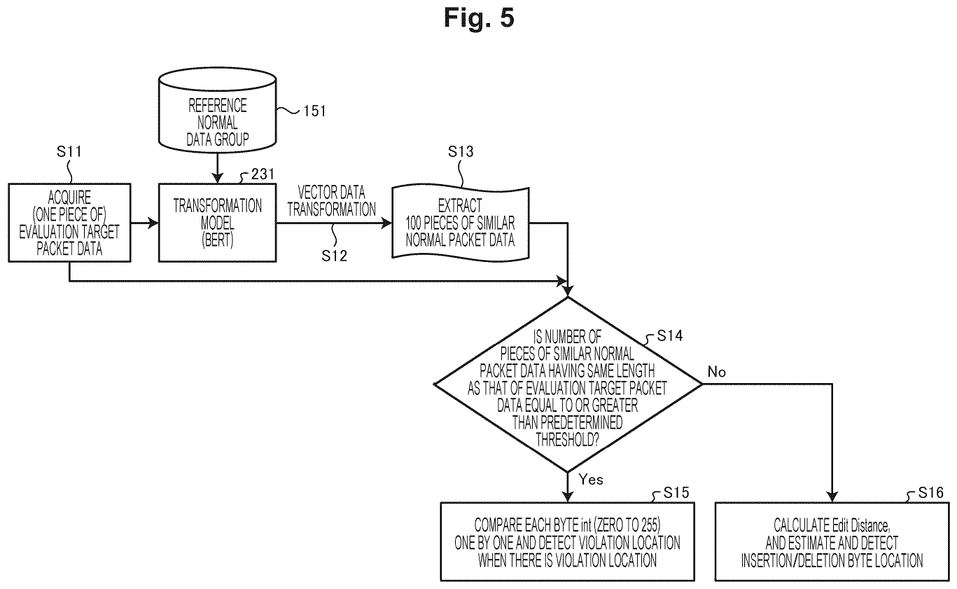

The reference normal data group 151 generated in step S3 of FIG. 3 is stored in the storage unit 15 and output to the detection device 20.

[Detection device] Next, the detection device 20 will be described. FIG. 4 is a diagram illustrating an example of a configuration of the detection device 20 illustrated in FIG. 1. FIG. 5 is a flowchart for describing a flow of processing of the detection device 20 illustrated in FIG. 4.

The detection device 20 is a device implemented by, for example, loading a predetermined program in a computer including a ROM, a RAM, a CPU, and the like and executing the predetermined program by the CPU. Furthermore, the detection device 20 includes a communication interface that transmits and receives various types of information to and from other devices connected via a network or the like.

The detection device 20 includes a storage unit 21 that stores the reference normal data group 151, an evaluation target data acquisition unit 22, a transformation unit 23 including the transformation model 231, an extraction unit 24, and a detection unit 25.

The evaluation target data acquisition unit 22 acquires one piece of evaluation target packet data (step S11 in FIG. 5).

The transformation unit 23 transforms the evaluation target packet data into vector data (hereinafter, referred to as evaluation target vector data) using the transformation model 231 (step S12 in FIG. 5). The transformation model 231 is a natural language processing model using BERT. The model parameters of the transformation model 121 trained for the vector transformation rule by the training device 10 are applied to the transformation model 231.

The extraction unit 24 extracts M pieces of similar normal packet data with relatively high similarity to the evaluation target packet data from the reference normal data group 151 (a plurality of pieces of normal packet data) on the basis of the natural language processing model (step S13 in FIG. 5). M is a hyperparameter and is set in advance. For example, M is 100.

The extraction unit 24 transforms each reference normal packet data of the reference normal data group 151 into vector data (reference normal vector data) using the transformation model 231. The extraction unit 24 calculates similarity between the reference normal vector data and the evaluation target vector data, for each reference normal vector data.

The extraction unit 24 calculates, for example, BERTScore as the similarity.

Furthermore, the extraction unit 24 may calculate the similarity between the vector of the evaluation target vector data and the vector of the reference normal vector data for each byte of the evaluation target vector data, and calculate the similarity between the evaluation target vector data and the reference normal vector data from the similarity calculated for each byte. As the similarity between the vectors of each byte, a cosine similarity may be used. The similarity between the evaluation target vector data and the reference normal vector data is, for example, the average similarity calculated for each byte. At this time, in a case where the number of vectors of the evaluation target vector data is different from the number of vectors of the reference normal vector data, the similarity may be calculated according to the small number of vectors. Note that the number of vectors of each vector data is the number of bytes of the packet data before transformation.

The extraction unit 24 may calculate the similarity to a part of the reference normal vector data in the reference normal vector data group. For example, a part of. the reference normal vector data is obtained by extracting a plurality of pieces of representative packet data from a plurality of pieces of the normal packet data by maximum mean discrepancy (MMD)-Critic and transforming each piece of the extracted representative packet data by a model. Alternatively, a part of the reference normal vector data is a plurality of pieces of reference normal vector data obtained by extracting reference normal packet data having the same packet length as that of the evaluation target packet data from the reference normal data group 151 and transforming each piece of the extracted reference normal packet data by a model.

The extraction unit 24 extracts M pieces of reference normal packet data with relatively high similarity. Hereinafter, the reference normal packet data extracted by the extraction unit 24 will be described as similar normal packet data.

Having a relatively high similarity means that the similarity between the evaluation target vector data and certain reference normal vector data is higher than the similarity between the evaluation target vector data and the other reference normal vector data. The extraction unit 24 extracts, as the similar normal packet data, a predetermined number of pieces of reference normal packet data in descending order of similarity from the reference normal packet data with the highest similarity. Alternatively, the extraction unit 24 may extract, as the similar normal packet data, M pieces of the reference normal packet data among pieces of the reference normal packet data with similarity higher than a threshold.

The detection unit 25 detects whether or not the packet data to be evaluated is abnormal on the basis of the anomaly score calculated by comparing M pieces of the similar normal packet data extracted by the extraction unit 24 with the evaluation target packet data.

The detection unit 25 extracts the packet data having the same packet length as that of the evaluation target packet data from the similar normal packet data. The detection unit 25 compares the evaluation target packet data with the packet data having the same packet length as that of the evaluation target packet data byte by byte to calculate a first anomaly score. Alternatively, in a case where the packet length of the similar normal packet data is different from the packet length of the evaluation target packet data, the detection unit 25 calculates a second anomaly score on the basis of an edit distance between the evaluation target packet data and the similar normal packet data.

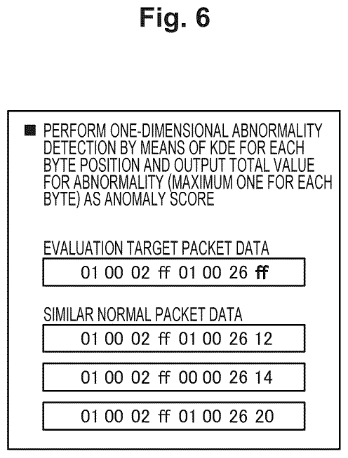

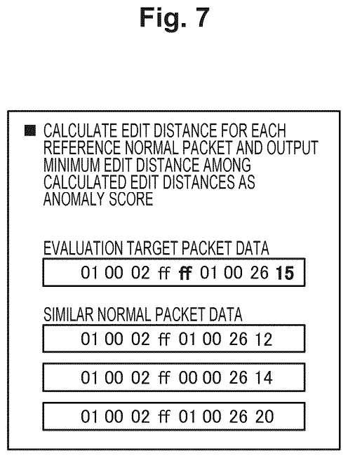

FIGS. 6 and 7 are diagrams for describing processing of the detection unit 25 illustrated in FIG. 4. The detection unit 25 performs calculation by comparing M pieces of the similar normal packet data extracted by the extraction unit 24 with the evaluation target packet data. The detection unit 25 includes a length comparison unit 251, a first calculation unit 252, and a second calculation unit 253.

The length comparison unit 251 compares the lengths of M pieces of the similar normal packet data and the length of the evaluation target packet data. The length comparison unit 251 determines whether or not the number of pieces of similar normal packet data having the same length as that of the evaluation target packet data among M pieces of the similar normal packet data is equal to or greater than a predetermined threshold (step S14 in FIG. 5). Note that the similar normal packet data having the same length as that of the evaluation target packet data is referred to as the same length normal packet data.

In a case where the length comparison unit 251 determines that the number of pieces of normal packet data. having the same length as that of the evaluation target packet data is equal to or greater than a predetermined threshold (step S14 in FIG. 5: Yes), the first calculation unit 252 performs the first calculation processing (step S15 in FIG. 5).

As the first calculation processing, the first calculation unit 252 performs one-dimensional detection on the same normal packet data as the evaluation target packet data on the basis of comparison of numerical values for each byte position to calculate an anomaly score at each byte position (FIG. 6). The first calculation unit 252 compares each byte int (zero to 255) one by one, detects a violation location when there is the violation location, and calculates the anomaly score. The first calculation unit 252 outputs the total value of the anomaly scores of all byte positions as the first anomaly score.

In a case where the length comparison unit 251 determines that the number of pieces of similar normal packet data having the same length as that of the evaluation target packet data is less than a predetermined threshold (step S14 in FIG. 5: No), the second calculation unit 253 performs the second calculation processing (step S16 in FIG. 5).

As the second calculation processing, the second calculation unit 253 calculates an edit distance between the evaluation target packet data and each similar normal packet data (FIG. 7). The second calculation unit 253 outputs the minimum edit distance among the calculated edit distances as the second anomaly score. Then, the second calculation unit 253 estimates and detects an insertion byte location suspected of being inserted or a deletion byte location suspected of being deleted, on the basis of the calculated edit distance.

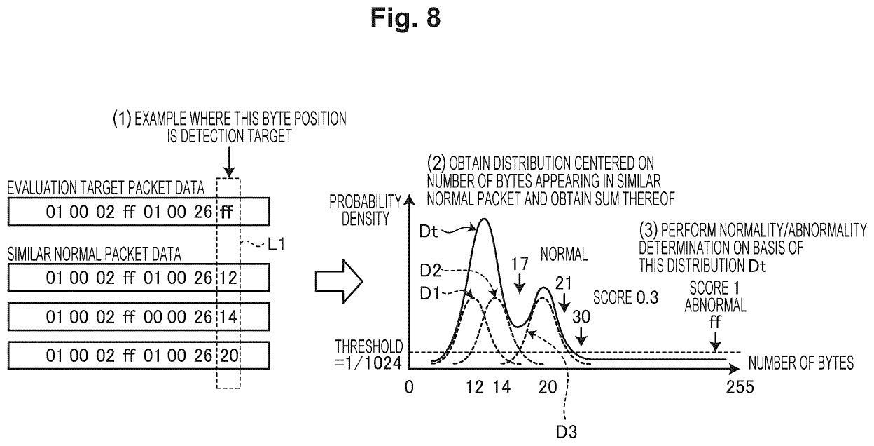

The detection unit 25 detects that the evaluation target packet data is abnormal and outputs an alert in a case where the first anomaly score or the second anomaly score exceeds a predetermined threshold.

[First calculation processing] the first calculation processing will be described. FIG. 8 is a diagram describing the first calculation processing.

Specifically, the first calculation unit 252 directly treats the value of the first byte of the similar normal packet data extracted for comparison as a number between “zero” and “255”. The first calculation unit 252 calculates the anomaly score by applying one-dimensional abnormality detection using, for example, a Kernel Density Estimator (KDE) (Reference Literature 3). The first calculation unit 252 similarly calculates the anomaly score for each of the second and subsequent bytes. The first calculation unit 252 performs one-dimensional detection on the basis of comparison of numerical values for each byte position to calculate the anomaly score at each byte position.

Reference Literature 3: Duda, R. and Hart, P. (1973), “PATTERN CLASSIFICATION AND SCENE ANALYSIS”, John Wiley & Sons. ISBN 0-471-22361-1.

The first calculation unit outputs the anomaly score in a range of minimum “zero” to maximum “one”. For example, a case where a byte position L1 is set as a detection target will be described as an example ((1) in FIG. 8).

The first calculation unit 252 obtains a probability density distribution of the byte value appearing at the byte position L1 of the similar normal packet data for each similar normal packet data. In other words, the first calculation unit 252 obtains a distribution centered on the number of bytes appearing in the similar normal packet and obtains the sum thereof ((2) in FIG. 8). For example, as the probability density distribution of the byte value at the byte position L1, among M pieces of the similar normal packet data, a probability density distribution D1 is obtained for the first similar normal packet data, a probability density distribution D2 is obtained for the second similar normal packet data, and a probability density distribution D3 is obtained for the third similar normal packet data.

The first calculation unit 252 obtains a probability density distribution Dt obtained by summing the probability density distributions (for example, the probability density distributions D1 to D3) of the similar normal packet data. The first calculation unit 252 observes what probability density a byte value of the evaluation target packet data has on the probability density distribution Dt, and performs normality/abnormality determination of the byte position L1 of the evaluation target packet data ((3) in FIG. 8).

Specifically, the first calculation unit 252 compares a predetermined threshold (for example, 1/1024) with the probability density of the byte value of the evaluation target packet data to calculate the anomaly score.

In a case where the probability density of the byte value of the evaluation target packet data is equal to or greater than a threshold (for example, byte values are respectively “17” and “21”), the first calculation unit 252 determines that the byte position L1 is normal and assigns zero as the anomaly score.

On the other hand, in a case where the probability density of the byte value of the evaluation target packet data is less than a threshold, that is, substantially “zero” (for example, a byte value is “ff”), the first calculation unit 252 determines that the byte position L1 is abnormal and assigns one as the anomaly score.

Furthermore, in a case where the probability density of the evaluation target packet data is equal to or greater than a threshold but is close to the threshold (for example, the byte value is “30”), the first calculation unit 252 may complement the anomaly score between zero and one according to a predetermined rule. For example, for the byte value of “30”, the first calculation unit 252 assigns 0.3 as the anomaly score.

In this manner, the first calculation unit 252 determines that there is no violation (normal) or there is a violation (abnormal) for each byte position on the basis of the probability density distribution Dt ((3) in FIG. 8). Therefore, even when the byte position is a byte position where the byte value randomly changes, it does not lead to false positive.

Then, the first calculation unit 252 calculates the anomaly score for each byte position, and outputs the total value as the final anomaly score (first anomaly score) for the evaluation target packet data.

Note that the first calculation unit 252 may use any one of a nonparametric method and a Naive Bayes method as an abnormality detection method that can treat one-dimensional data.

[Second calculation processing] Next, the second calculation processing will be described. In the second calculation processing, the second calculation unit 253 calculates the edit distance between the evaluation target packet data and each similar normal packet data using a dynamic programming method.

The second calculation unit 253 directly outputs the calculated edit distance as the anomaly score. Specifically, the second calculation unit 253 uses the minimum edit distance among the calculated edit distances as the second anomaly score.

Moreover, by calculating the edit distance, for example, in a case where insertion and/or deletion of the abnormal byte is suspected, the second calculation unit 253 specifies the position and directly specifies how many packets are inserted. Furthermore, in a case where the similar normal packet data does not exist, it is considered that the edit distance increases.

The second calculation unit 253 acquires the evaluation target packet data and M pieces of the similar normal packet data from the length comparison unit 251. Then, the second calculation unit 253 compares the acquired similar normal packet data with the evaluation target packet data in order to specify an insertion byte location or a deletion byte location of the byte in the evaluation target packet data.

Specifically, the second calculation unit 253 calculates the edit distance between the evaluation target packet data and each similar normal packet data using a dynamic programming method. The second calculation unit 253 can specify the insertion byte location suspected of being inserted or the deletion byte location suspected of being deleted, by calculating the edit distance.

Then, in a case where the similar normal packet data with an edit distance less than a certain distance exists, the second calculation unit 253 selects the similar normal packet data with the shortest edit distance as final similar normal packet data among pieces of the similar normal packet data with an edit distance less than the certain distance. Then, the second calculation unit 253 estimates the insertion/deletion byte locations using the edit distance of the selected final similar normal packet data.

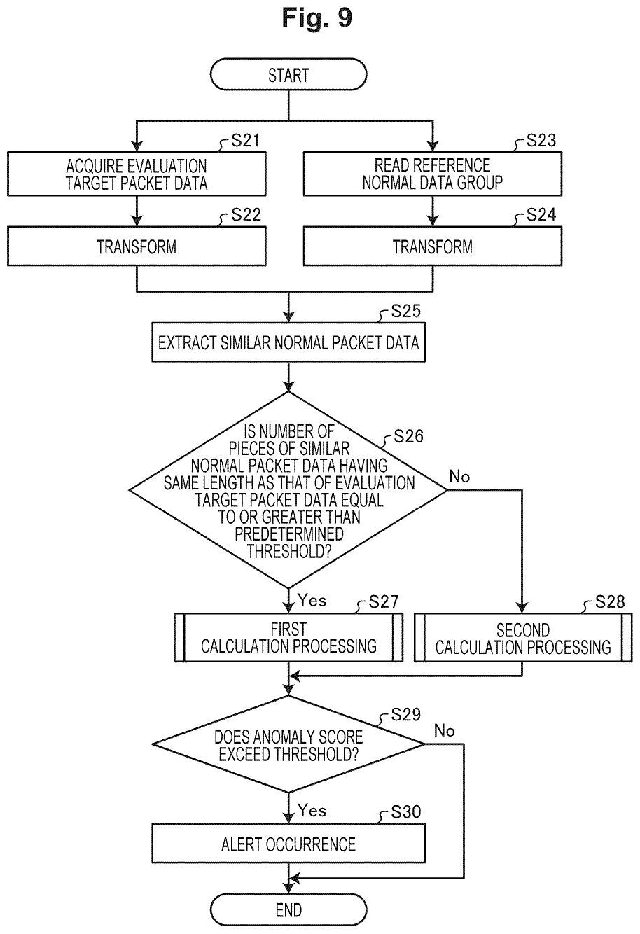

On the other hand, in a case where the edit distance is equal to or greater than a certain distance in all pieces of the acquired similar normal packet data, the second calculation unit 253 performs processing without the final similar normal packet data corresponding to the evaluation target packet data. Here, the certain distance is, for example, a parameter that can specify about ⅓ to ½ of the packet length.

[Processing procedure of detection processing] FIG. 9 is a flowchart illustrating a procedure of detection processing according to the first embodiment.

The detection device 20 acquires one piece of evaluation target packet data (step S21). The transformation unit 23 transforms the evaluation target packet data into evaluation target vector data using the transformation model 231 (step S22).

The extraction unit 24 reads each reference normal packet data of the reference normal data group 151 (step S23) and transforms each reference normal packet data into reference normal vector data using the transformation model 231 (step S24).

The extraction unit 24 extracts M pieces of the reference normal vector data with a relatively high similarity to the evaluation target vector data as similar reference normal vector data (step S25).

The extraction unit 24 calculates the similarity between the reference normal vector data and the evaluation target vector data, for each reference normal vector data. The extraction unit 24 extracts M pieces of the similar normal packet data with a relatively high similarity on the basis of each calculated similarity (step S25).

The length comparison unit 251 compares the lengths of M pieces of the similar normal packet data and the length of the evaluation target packet data. The length comparison unit 251 determines whether or not the number of pieces of the similar normal packet data having the same length as that of the evaluation target packet data among M pieces of the similar normal packet data is equal to or greater than a predetermined threshold (step S26).

In a case where the number of pieces of the similar normal packet data having the same length as that of the evaluation target packet data is equal to or greater than a predetermined threshold (step S26: Yes), the first calculation unit 252 performs the first calculation processing (step S27) and outputs the first anomaly score.

In a case where the number of pieces of the similar normal packet data having the same length as that of the evaluation target packet data is less than a predetermined threshold (step S26: No), the second calculation unit 253 performs the second calculation processing (step S28) and outputs the second anomaly score.

The detection unit 25 determines whether or not the first anomaly score or the second anomaly score exceeds a predetermined threshold (step S29).

In a case where the first anomaly score or the second anomaly score exceeds the predetermined threshold (step S29: Yes), the detection unit 25 detects abnormality of the evaluation target packet data and outputs an alert (step S30).

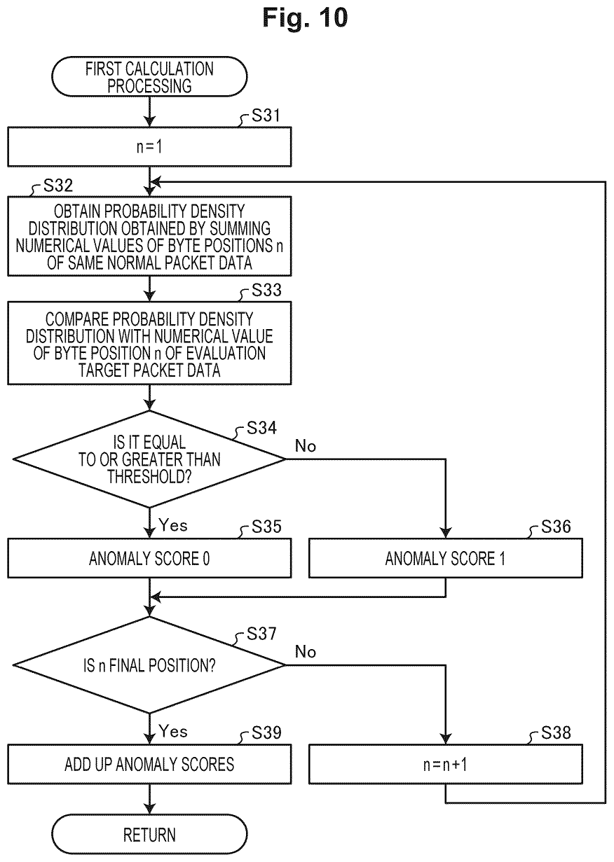

Furthermore, in a case where the first anomaly score or the second anomaly score is equal to or less than the predetermined threshold (step S29: No), the detection device 20 ends the detection processing on the evaluation target packet data.

[First calculation processing] FIG. 10 is a flowchart illustrating a procedure of the first calculation processing illustrated in FIG. 9.

The first calculation unit 252 sets a parameter n representing a position of a byte to be compared to n=1 (step S31).

The first calculation unit 252 obtains the probability density distribution Dt obtained by summing the numerical values of byte positions n of the same normal packet data (step S32). The first calculation unit 252 compares the probability density distribution Dt with the numerical value of the byte position n of the evaluation target packet data (step S33). Then, the first calculation unit 252 compares a predetermined threshold (for example, 1/1024) with the numerical value of the byte position n of the evaluation target packet data, and determines whether or not the numerical value of the byte position n of the evaluation target packet data is equal to or greater than this threshold (step S34).

In a case where the numerical value of the byte position n of the evaluation target packet data is equal to or greater than the threshold (Step S34: Yes), the first calculation unit 252 assigns zero as the anomaly score of the byte position n (step S35). The first calculation unit 252 may complement the anomaly score between zero and one according to a predetermined rule.

In a case where the numerical value of the byte position n of the evaluation target packet data is less than the threshold (Step S34: No), the first calculation unit 252 assigns one as the anomaly score of the byte position n (step S36).

In a case where the byte position n is not the final position (step 837: No), the first calculation unit 252 sets n=n+1 (step S38), and performs the processing of step S32 and subsequent steps on the numerical value of the next byte position to calculate the anomaly score.

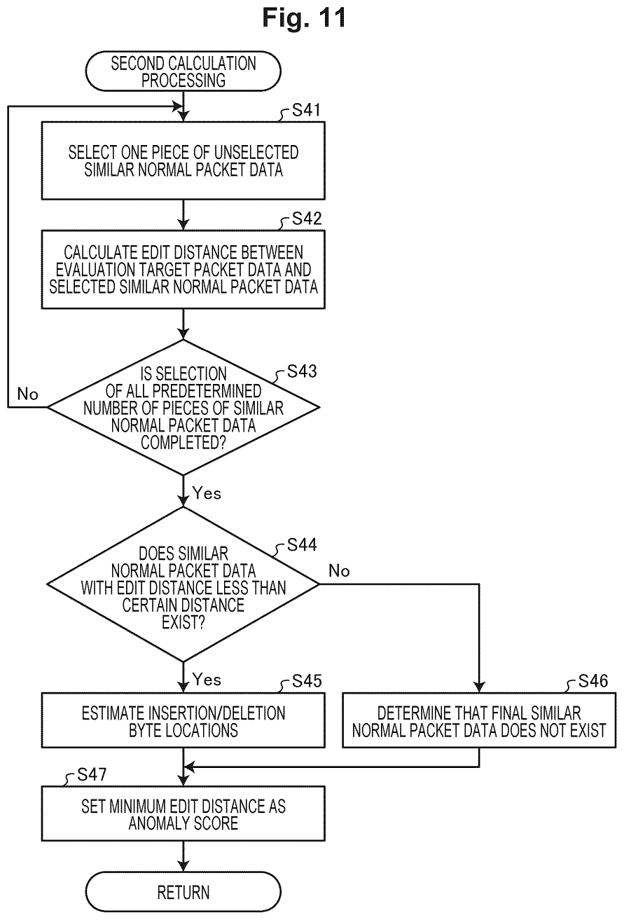

In a case where the byte position n is the final position (step S37: Yes), the first calculation unit 252 adds up the anomaly scores of all the byte positions (step S39), and outputs the total value of the anomaly scores as the first anomaly score for the evaluation target packet data.

[Second calculation processing] FIG. 11 is a flowchart illustrating a procedure of the second calculation processing illustrated in FIG. 9.

The second calculation unit 253 selects one piece of unselected similar normal packet data from a predetermined number of pieces of the similar normal packet data (step S41).

Next, the second calculation unit 253 calculates the edit distance between the evaluation target packet data and the selected similar normal packet data using a dynamic programming method (step S42).

Next, the second calculation unit 253 determines whether or not the selection of all the predetermined number of pieces of the similar normal packet data is completed (step S43). In a case where the unselected normal packet data remains among the predetermined number of pieces of the similar normal packet data (step S43; No), the second calculation unit 253 returns to step S41.

On the other hand, in a case where the selection of all the predetermined number of pieces of the similar normal packet data is completed (step S43: Yes), the second calculation unit 253 determines whether or not the similar normal packet data with an edit distance less than a certain distance exists (step S44).

In a case where the similar normal packet data with an edit distance less than a certain distance exists (step S44: Yes), the second calculation unit 253 executes the following processing. In this case, the second calculation unit 253 selects the similar normal packet data with the shortest edit distance as final similar normal packet data among pieces of the similar normal packet data with the edit distance less than the certain distance. Then, the second calculation unit 253 estimates the insertion/deletion byte locations using the edit distance between the selected final similar normal packet data and the evaluation target packet data (step S45).

On the other hand, in a case where the similar normal packet data with the edit distance less than a certain distance does not exist (step S44: No), the second calculation unit 253 determines that the final similar normal packet data does not exist (step S46).

The second calculation unit 253 outputs the minimum edit distance among the calculated edit distances as the second anomaly score (step S47). Then, the second calculation unit 253 estimates an insertion byte location suspected of being inserted or a deletion byte location suspected of being deleted and outputs the deletion result.

[Evaluation experiment] Next, a result of the evaluation experiment will be described. 451 pieces of training packet data and 439 pieces of reference normal packet data were extracted in the communication (average packet length of 93.5, maximum packet length of 816) of a BACnet protocol acquired in a small-scale experiment environment. The evaluation target packet data was generated in a pseudo manner by rewriting a random location of 1 to 5 bytes with a random byte for the reference normal packet data. Furthermore, the training data itself of BERT was used as the reference normal packet data.

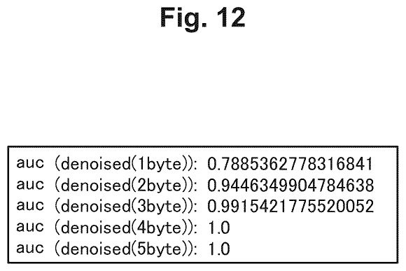

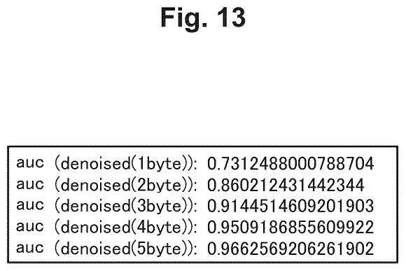

FIGS. 12 and 13 are diagrams illustrating the result of the evaluation experiment. FIG. 12 illustrates a detection result obtained from the detection device 20.

FIG. 13 illustrates a detection result obtained using the method described in Patent Literature 1. Note that the evaluation was performed using AUROC. As the detection accuracy, an AUC score is desirably equal to or greater than 0.95.

As illustrated in FIGS. 12 and 13, the detection accuracy of the detection device 20 was higher than that of the method described in Patent Literature 1. Furthermore, as illustrated in FIG. 12, in a case where it is detected by the detection device 20, the AUC score greatly exceeds 0.95 as compared with the data with more than 3 bytes modified, and it is almost completely detectable.

[Effects of first embodiment] As also shown in this evaluation experiment, according to the first embodiment, it is possible to detect an abnormality occurring in the content of a packet with higher accuracy for an arbitrary communication protocol with a long packet length.

[Second embodiment] In a second embodiment, a detection device that detects abnormality of communication data (payload) will be described.

The detection device according to the second embodiment implements high-speed processing of extracting data similar to the evaluation target packet data from the normal communication data by natural language processing using BERT.

For example, in a case where the similar normal packet data is extracted, the detection device 20 according to the first embodiment calculates the similarity for one evaluation target packet by the number of reference normal packets included in the reference normal data group 151.

Therefore, the processing cost of the detection device 20 is the cost shown in Equation (1).

Processing cost=(Number of evaluation target packets)×(Number of pieces of reference normal packet data)×(Number of bytes of evaluation target packet)×(Number of bytes of reference normal packet data) ... (1)

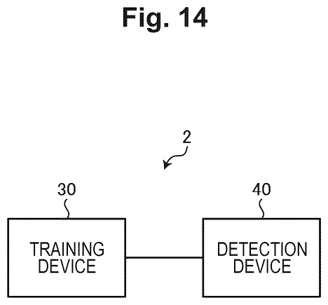

The detection device according to the second embodiment can extract the similar normal packet data at the processing cost lower than the processing cost of the detection device 20 according to the first embodiment by efficiently reducing the “number of pieces of reference normal packet data” included in Equation (1).

[Detection system] Next, a detection system according to the second embodiment will be described. FIG. 14 is a diagram illustrating an example of a configuration of the detection system according to the second embodiment.

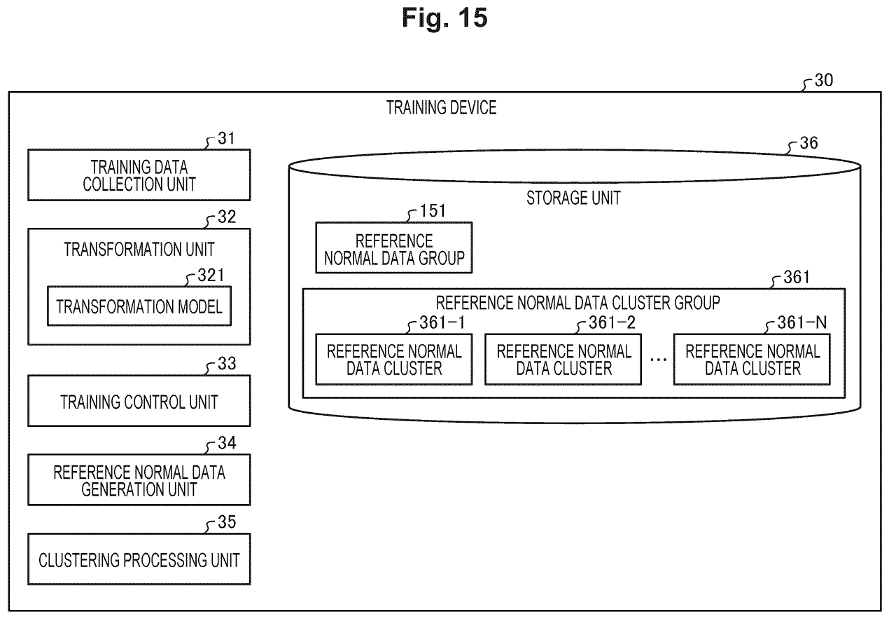

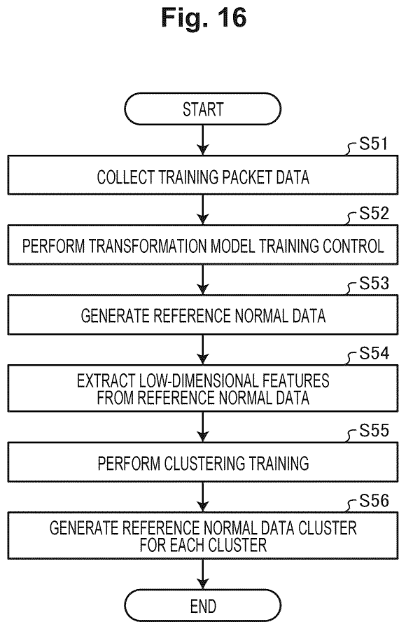

As illustrated in FIG. 14, a detection system 2 includes a training device 30 that executes training of a natural language processing model used by a detection device 40 and the detection device 40 that detects abnormality of communication data (payload) using the natural language processing model for which the training has been executed by the training device 30.

[Training device] FIG. 15 is a diagram illustrating an example of a configuration of the training device 30 illustrated in FIG. 14. FIG. 16 is a flowchart for describing a procedure of training processing executed by the training device 30 illustrated in FIG. 15.

The training device 30 is a device implemented by, for example, loading a predetermined program in a computer including a ROM, a RAM, a CPU, and the like and executing the predetermined program by the CPU. Furthermore, the training device 30 includes a communication interface that transmits and receives various types of information to and from other devices connected via a network or the like.

The training device 30 includes a training data collection unit 31, a transformation unit 32 including a transformation model 321, a training control unit 33, a reference normal data generation unit 34, a clustering processing unit 35, and a storage unit 36.

The training data collection unit 31 collects training packet data of the transformation model 321 (step S51 in FIG. 16).

The training control unit 33 performs transformation model training control for training the transformation model 321 to learn a packet transformation rule using the training packet data (step S52 in FIG. 16). The model parameters of the transformation model 321 optimized in step S52 are applied to a transformation model 441 (to be described later) of the detection device 40.

The transformation unit 32 transforms packet data into vector data using the transformation model 321. The vector data is data in which each byte of packet data is associated with each vector representing a characteristic of a value of each byte. The training control unit 33 trains the transformation model 321 to learn a value of each byte of the training packet data.

The transformation model 321 is, for example, a natural language processing model using BERT. The transformation model 321 transforms a value of each byte of each communication packet, which is the training packet data, into a 784-dimensional vector. In step S52 of FIG. 16, the transformation model 321 performs learning of a rule of transformation into vector data in which the position of each byte of the communication packet is associated with the 784-dimensional vector transformed from the byte.

Note that the training control unit 33 may control the characteristic of the value of each byte in the training packet data to execute preliminary training by solving an auxiliary task such as MLM or NSP, similarly to the training control unit 13.

The reference normal data generation unit 34 generates the reference normal data group 151 using the training packet data (step S53 in FIG. 16). The reference normal data generation unit 34 sets a packet data group sampled from the training packet data as the reference normal data group 151.

At this time, the reference normal data generation unit 34 performs sampling, for example, using a sampling method such as kernel herding. In this case, random sampling is not performed in order to suppress occurrence of performance deterioration. Note that although it is desirable to perform sampling from the viewpoint of the processing speed, all pieces of training packet data may be used as the reference normal data group 151.

The reference normal data group 151 generated by the reference normal data generation unit 34 in step S53 of FIG. 16 is stored in the storage unit 36.

The clustering processing unit 35 acquires the reference normal data group 151 stored in the storage unit 36, and extracts a low-dimensional features from each reference normal data included in the reference normal data group 151 (step S54 in FIG. 16). For example, the clustering processing unit 35 may extract low-dimensional features using a technology such as principal component analysis, linear discriminant analysis, t-SNE (t-Distributed Stochastic Neighbor Embedding), or an autoencoder, or may extract low-dimensional features using other conventional technologies.

Note that a user may manually set low-dimensional features for each reference normal data included in the reference normal data group 151. In this case, the clustering processing unit 35 executes the following processing using the low-dimensional features set in advance for each reference normal data.

The clustering processing unit 35 performs learning of clustering on the basis of the low-dimensional features of each reference normal data (step S55 in FIG. 16). For example, the clustering processing unit 35 performs a process of comparing the low-dimensional features of each reference normal data and classifying the reference normal data with similar features into the same cluster. For example, the clustering processing unit 35 performs learning of clustering by performing k-means clustering, hierarchical clustering, density-based clustering, and the like.

For example, the clustering processing unit 35 generates a reference normal data cluster group 361 by performing learning of clustering for the reference normal data group 151 (step S56 in FIG. 16). The reference normal data cluster group 361 includes reference normal data clusters 361-1, 361-2, . . . and 361-N.

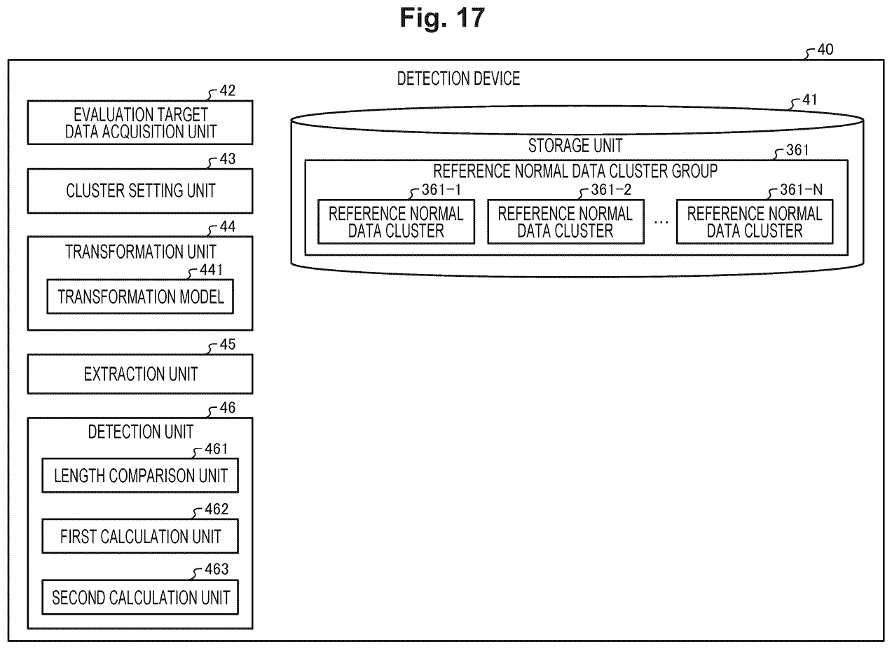

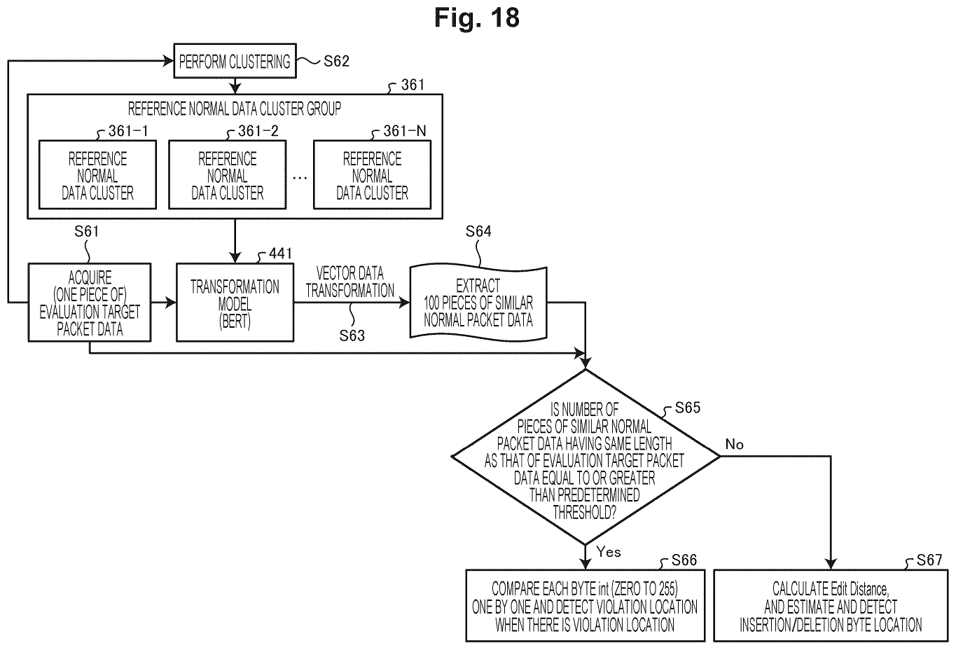

The reference normal data cluster group 361 generated in step S56 of FIG. 16 is stored in the storage unit 36 and output to the detection device 40.

[Detection device] Next, the detection device 40 will be described. FIG. 17 is a diagram illustrating an example of a configuration of the detection device 40 illustrated in FIG. 14. FIG. 18 is a flowchart for describing a flow of processing of the detection device 40 illustrated in FIG. 17.

The detection device 40 is a device implemented by, for example, loading a predetermined program in a computer including a ROM, a RAM, a CPU, and the like and executing the predetermined program by the CPU. Furthermore, the detection device 40 includes a communication interface that transmits and receives various types of information to and from other devices connected via a network or the like.

The detection device 40 includes a storage unit 41 that stores the reference normal data cluster group 361, an evaluation target data acquisition unit 42, a cluster setting unit 43, a transformation unit 44 including the transformation model 441, an extraction unit 45, and a detection unit 46.

The evaluation target data acquisition unit 42 acquires one piece of evaluation target packet data (step S61 in FIG. 18). The evaluation target data acquisition unit 42 outputs the evaluation target packet data to the cluster setting unit 43 and the transformation unit 44.

The cluster setting unit 43 extracts low-dimensional features from the evaluation target packet data to perform clustering, selects any one reference normal data cluster from the reference normal data clusters 361-1 to 361-N included in the reference normal data cluster group 361, and sets the selected reference normal data cluster in the transformation model 441 (step S62 in FIG. 18). In the following description, the reference normal data cluster set by the cluster setting unit 43 is referred to as a “set cluster”.

Note that the user may manually set the low-dimensional features of the evaluation target packet data, and the cluster setting unit 43 may use the low-dimensional features. Furthermore, the cluster setting unit 43 may extract low-dimensional features of the reference normal data, or may use the low-dimensional features set in advance, similarly to the clustering processing unit 35 of the training device 30.

For example, the cluster setting unit 43 may perform the following processing to select a set cluster. The cluster setting unit 43 selects one piece of reference normal data from pieces of the reference normal data included in the reference normal data cluster 361-1, extracts low-dimensional features of the selected reference normal data, and sets the extracted low-dimensional features as low-dimensional features of the reference normal data cluster 361-1. The cluster setting unit 43 similarly extracts low-dimensional features for the other reference normal data clusters 361-2 to 361-N.

The cluster setting unit 43 compares the low-dimensional features of the evaluation target packet data with the low-dimensional features of the reference normal data clusters 361-1 to 361-N, respectively, and calculates each similarity. The cluster setting unit 43 selects, as the set cluster, the reference normal data cluster corresponding to the low-dimensional features with the maximum similarity to the low-dimensional features of the evaluation target packet data.

The transformation unit 44 transforms the evaluation target packet data into vector data (hereinafter, referred to as evaluation target vector data) using the transformation model 441 (step S63 in FIG. 18). The transformation model 441 is a natural language processing model using BERT. The model parameters of the transformation model 321 trained for the vector transformation rule by the training device 30 are applied to the transformation model 441.

The extraction unit 45 extracts X pieces of similar normal packet data with relatively high similarity to the evaluation target packet data from the set cluster (a plurality of pieces of normal packet data) on the basis of the natural language processing model (step S64 in FIG. 18). X is a hyperparameter and is set in advance. For example, X is 100.

The extraction unit 45 transforms each reference normal packet data of the set cluster into vector data (reference normal vector data) using the transformation model 441. The extraction unit 45 calculates the similarity between the reference normal vector data and the evaluation target vector data, for each reference normal vector data.

Since the description regarding the processing of calculating the similarity by the extraction unit 45 is similar to the description regarding the processing of calculating the similarity by the extraction unit 24 of the first embodiment described above, the description thereof will be omitted. Note that while the extraction unit 24 executes the processing of calculating the similarity for each reference normal packet data of the reference normal data group 151, the extraction unit 45 executes the processing of calculating the similarity only for each reference normal packet data included in the setting cluster. Therefore, the extraction unit 45 of the second embodiment can achieve the high-speed of the processing related to the calculation of the similarity as compared with the extraction unit 24 of the first embodiment.

The extraction unit 45 extracts X pieces of reference normal packet data with relatively high similarity. Hereinafter, the reference normal packet data extracted by the extraction unit 45 will be described as similar normal packet data.

Having a relatively high similarity means that the similarity between the evaluation target vector data and certain reference normal vector data is higher than the similarity between the evaluation target vector data and the other reference normal vector data. The extraction unit 45 extracts, as the similar normal packet data, a predetermined number of pieces of reference normal packet data in descending order of similarity from the reference normal packet data with the highest similarity. Alternatively, the extraction unit 45 may extract, as the similar normal packet data, X pieces of the reference normal packet data among pieces of the reference normal packet data with similarity higher than a threshold.

The detection unit 46 detects whether or not the packet data to be evaluated is abnormal on the basis of the anomaly score calculated by comparing M pieces of the similar normal packet data extracted by the extraction unit 45 with the evaluation target packet data.

The detection unit 46 extracts the packet data having the same packet length as that of the evaluation target packet data from the similar normal packet data. The detection unit 46 compares the evaluation target packet data with the packet data having the same packet length as that of the evaluation target packet data byte by byte to calculate the first anomaly score. Alternatively, in a case where the packet length of the similar normal packet data is different from the packet length of the evaluation target packet data, the detection unit 46 calculates the second anomaly score on the basis of the edit distance between the evaluation target packet data and the similar normal packet data.

The detection unit 46 performs calculation by comparing X pieces of the similar normal packet data extracted by the extraction unit 45 with the evaluation target packet data. The detection unit 46 includes a length comparison unit 461, a first calculation unit 462, and a second calculation unit 463.

The length comparison unit 461 compares the lengths of X pieces of the similar normal packet data and the length of the evaluation target packet data. The length comparison unit 461 determines whether or not the number of pieces of similar normal packet data having the same length as that of the evaluation target packet data among X pieces of the similar normal packet data is equal to or greater than a predetermined threshold (step S65 in FIG. 18). Note that the similar normal packet data having the same length as that of the evaluation target packet data is referred to as the same length normal packet data.

In a case where the length comparison unit 461 determines that the number of pieces of normal packet data having the same length as that of the evaluation target packet data is equal to or greater than a predetermined threshold (step S65 in FIG. 18: Yes), the first calculation unit 462 performs the first calculation processing (step S66 in FIG. 18).

As the first calculation processing, the first calculation unit 462 performs one-dimensional detection on the same normal packet data as the evaluation target packet data on the basis of comparison of numerical values for each byte position to calculate an anomaly score at each byte position (FIG. 6). The first calculation unit 462 compares each byte int (zero to 255) one by one, detects a violation location when there is the violation location, and calculates the anomaly score. The first calculation unit 462 outputs the total value of the anomaly scores of all byte positions as the first anomaly score.

In a case where the length comparison unit 461 determines that the number of pieces of similar normal packet data having the same length as that of the evaluation target packet data is less than a predetermined threshold (step S65 in FIG. 18: No), the second calculation unit 463 performs the second calculation processing (step S67 in FIG. 18).

As the second calculation processing, the second calculation unit 463 calculates an edit distance between the evaluation target packet data and each similar normal packet data (FIG. 7). The second calculation unit 463 outputs the minimum edit distance among the calculated edit distances as the second anomaly score. Then, the second calculation unit 463 estimates and detects an insertion byte location suspected of being inserted or a deletion byte location suspected of being deleted, on the basis of the calculated edit distance.

The detection unit 46 detects that the evaluation target packet data is abnormal and outputs an alert in a case where the first anomaly score or the second anomaly score exceeds a predetermined threshold.

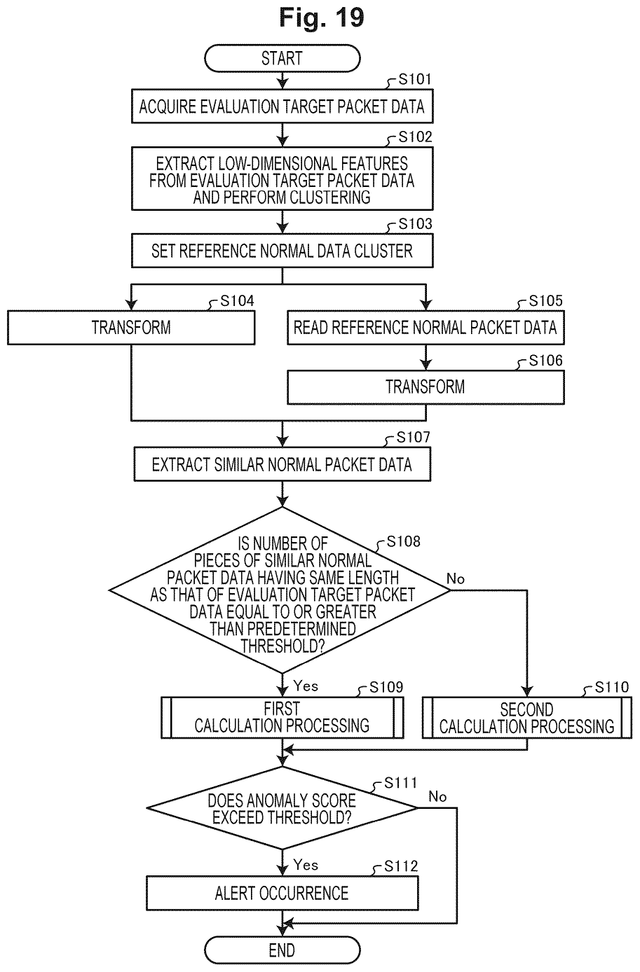

Note that the first calculation processing executed by the first calculation unit 462 is similar to the first calculation processing described in the first embodiment. The second calculation processing executed by the second calculation unit 463 is similar to the second calculation processing described in the first embodiment.

[Processing procedure of detection processing] FIG. 19 is a flowchart illustrating a procedure of detection processing according to the second embodiment.

The detection device 40 acquires one piece of evaluation target packet data (step S101). The cluster setting unit 43 extracts low-dimensional features from the evaluation target packet data and performs clustering (step S102). The cluster setting unit 43 sets the reference normal data cluster (step S103).

The transformation unit 44 transforms the evaluation target packet data into evaluation target vector data using the transformation model 441 (step S104).

The extraction unit 45 reads each reference normal packet data of the set cluster (step S105) and transforms each reference normal packet data into reference normal vector data using the transformation model 441 (step S106).

The extraction unit 45 extracts X pieces of the reference normal vector data with a relatively high similarity to the evaluation target vector data as similar reference normal vector data (step S107).

The extraction unit 45 calculates the similarity between the reference normal vector data and the evaluation target vector data, for each reference normal vector data. The extraction unit 24 extracts X pieces of the similar normal packet data with a relatively high similarity on the basis of each calculated similarity (step S107).

The length comparison unit 461 compares the lengths of X pieces of the similar normal packet data and the length of the evaluation target packet data. The length comparison unit 461 determines whether or not the number of pieces of the similar normal packet data having the same length as that of the evaluation target packet data among X pieces of the similar normal packet data is equal to or greater than a predetermined threshold (step S108).

In a case where the number of pieces of the similar normal packet data having the same length as that of the evaluation target packet data is equal to or greater than a predetermined threshold (step S108: Yes), the first calculation unit 462 performs the first calculation processing (step S109) and outputs the first anomaly score.

In a case where the number of pieces of the similar normal packet data having the same length as that of the evaluation target packet data is less than a predetermined threshold (step S108: No), the second calculation unit 463 performs the second calculation processing (step S110) and outputs the second anomaly score.

The detection unit 46 determines whether or not the first anomaly score or the second anomaly score exceeds a predetermined threshold (step S111).

In a case where the first anomaly score or the second anomaly score exceeds the predetermined threshold (step S111: Yes), the detection unit 46 detects abnormality of the evaluation target packet data and outputs an alert (step S112).

Furthermore, in a case where the first anomaly score or the second anomaly score is equal to or less than the predetermined threshold (step S111: No), the detection device 40 ends the detection processing on the evaluation target packet data.

Note that the procedure of the first calculation processing illustrated in step S109 of FIG. 19 is similar to the procedure of the first calculation processing described in FIG. 10. The procedure of the second calculation processing illustrated in step S110 of FIG. 19 is similar to the procedure of the second calculation processing described in FIG. 11.

[Effects of second embodiment] The extraction unit 45 of the detection device 40 according to the second embodiment executes the processing of calculating the similarity only for each reference normal packet data included in the set cluster. Therefore, the extraction unit 45 of the second embodiment can achieve the high-speed of the processing related to the calculation of the similarity as compared with the extraction unit 24 of the detection device 20 according to the first embodiment. For example, the detection device 40 can extract the similar normal packet data at the processing cost lower than the processing cost of the detection device 20 according to the first embodiment by efficiently reducing the “number of pieces of reference normal packet data” included in Equation (1).

[Application example] The first and second embodiments can be applied to, for example, an abnormality detection system of an IoT device.

Specifically, a network sensor is disposed in an IoT network, and packet capture is performed. Then, training of an encoding unit (BERT) is performed using the captured packet. After the training is completed, the reference normal packet data is set in the detection device 20 (detection device 40). Thereafter, the packet acquired by the network sensor is input to the detection device 20, and the anomaly score is calculated for each packet. Whether or not the evaluation target packet is similar to the packet acquired at the time of training (that is, whether or not the packet is a normal packet) is detected using the anomaly score.

[Regarding system configuration of embodiment] Each component of the training devices 10 and 30 and the detection devices 20 and 40 is functionally conceptual, and does not have to be physically configured as illustrated in drawings. That is, specific forms of distribution and integration of the functions of the training devices 10 and 30 and the detection devices 20 and 40 are not limited to the illustrated forms, and all or a part thereof can be functionally or physically distributed or integrated in any unit according to various loads, usage conditions, and the like.

Furthermore, all or any part of the processing performed in the training devices 10 and 30 and the detection devices 20 and 40 may be implemented by a CPU and a program analyzed and executed by the CPU. Furthermore, each processing performed in the training devices 10 and 30 and the detection devices 20 and 40 may be implemented as hardware by wired logic.

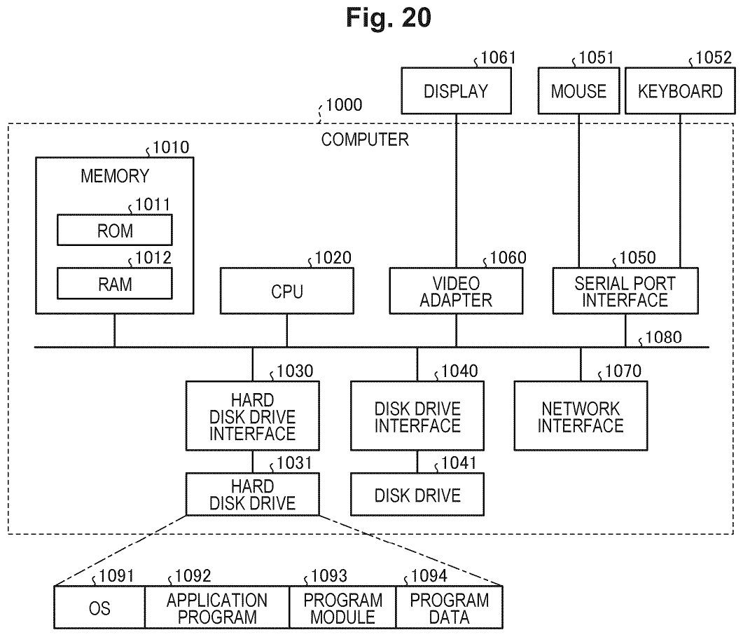

Furthermore, in the processing described in the first and second embodiments, all or part of the processing described as being automatically performed can be performed manually. Alternatively, all or part of the processing described as being manually performed can be automatically performed by a known method. Additionally, the above-described and illustrated processing procedures, control procedures, specific names, and information including various types of data and parameters may be appropriately changed unless otherwise specified.

[Program] FIG. 20 is a diagram illustrating an example of a computer in which the training device 10 and the detection device 20 are implemented by executing a program. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a detachable storage medium such as a magnetic disk or an optical disk is inserted into the disk drive 1041. The serial port interface 1050 is connected to, for example, a mouse 1051 and a keyboard 1052. The video adapter 1060 is connected to, for example, a display 1061.

The hard disk drive 1031 stores, for example, an OS 1091, an application program 1092, a program module 1093, and program data 1094. That is, the program that defines each processing of the training devices 10 and 30 and the detection devices 20 and 40 is implemented as the program module 1093 in which a code executable by the computer 1000 is described. The program module 1093 is stored, for example, in the hard disk drive 1031. For example, the program module 1093 for executing processing similar to the functional configuration of the training devices 10 and 30 and the detection devices 20 and 40 is stored in the hard disk drive 1031. Note that the hard disk drive 1031 may be replaced with a solid state drive (SSD).

Furthermore, the setting data that is used in the processing according to the above-described embodiments is stored as the program data 1094, for example, in the memory 1010 or the hard disk drive 1031. The CPU 1020 loads the program module 1093 and the program data 1094 stored in the memory 1010 or the hard disk drive 1031 into the RAM 1012 as necessary and executes them.

Note that the program module 1093 and the program data 1094 are not limited to being stored in the hard disk drive 1031, and may be stored in, for example, a detachable storage medium and read by the CPU 1020 via the disk drive 1041 or the like. Alternatively, the program module 1093 and the program data 1094 may be stored in another computer connected via a network (such as a local area network (LAN) and a wide area network (WAN) ). Then, the program module 1093 and the program data 1094 may be read by the CPU 1020 from another computer via the network interface 1070.

Although the embodiment to which the invention made by the present inventor is applied has been described above, the present invention is not limited by the description and drawings according to the present embodiment, which constitute a part of the disclosure of the present invention. That is, other embodiments, examples, operation techniques, and the like made by those skilled in the art and the like on the basis of the present embodiment are all included in the scope of the present invention.

### REFERENCE SIGNS LIST

10, 30 Training device
11, 31 Training data collection unit
12, 23, 32, 44 Transformation unit
13, 33 Training control unit
14, 34 Reference normal data generation unit
15, 21, 36, 41 Storage unit
20, 40 Detection device
22, 42 Evaluation target data acquisition unit
24, 45 Extraction unit
25, 46 Detection unit
121, 231, 321, 441 Transformation model
151 Reference normal data group
251, 461 Length comparison unit
252, 462 First calculation unit
253, 463 Second calculation unit
361 Reference normal data cluster group

1. A detection device comprising:
a memory; and
processing circuitry configured to:
extract a predetermined number of pieces of similar normal packet data with a relatively high similarity to evaluation target packet data from a plurality of pieces of normal packet data on a basis of a natural language processing model; and
detect whether or not the evaluation target packet data is abnormal on the basis of an anomaly score calculated by comparing a predetermined number of pieces of the similar normal packet data extracted with the evaluation target packet data.

2. The detection device according to claim 1, wherein the processing circuitry is further configured to
extract packet data having a same packet length as that of the evaluation target packet data from pieces of the similar normal packet data, and compare the evaluation target packet data with the packet data having the same packet length as that of the evaluation target packet data byte by byte to calculate a first anomaly score, and
calculate a second anomaly score on the basis of an edit distance between the evaluation target packet data and the similar normal packet data in a case where the similar normal packet data is different from the evaluation target packet data in packet length.

3. The detection device according to claim 2, wherein the processing circuitry is further configured to perform one-dimensional detection on the evaluation target packet data and the packet data having the same packet length as that of the evaluation target packet data on the basis of a comparison of numerical values for each byte position to calculate an anomaly score at each byte position, and set a total value of the anomaly scores for all the byte positions as the first anomaly score.

4. The detection device according to claim 2, wherein the processing circuitry is further configured to calculate the edit distance between the evaluation target packet data and the similar normal packet data, and set a minimum edit distance among the calculated edit distances as the second anomaly score.

5. The detection device according to claim 1, wherein the processing circuitry is further configured to use Bidirectional Encoder Representations from Transformers (BERT) as the natural language processing model.

6. The detection device according to claim 1, wherein the processing circuitry is further configured to
select one of a plurality of clusters obtained by clustering the plurality of pieces of normal packet data on the basis of features of the plurality of pieces of normal packet data on the basis of features of the plurality of clusters and features of the evaluation target packet data, and
extract a predetermined number of pieces of similar normal packet data with a relatively high similarity to the evaluation target packet data from the plurality of pieces of normal packet data included in the selected cluster on the basis of the natural language processing model.

7. A detection method executed by a detection device, the detection method comprising:
extracting a predetermined number of pieces of similar normal packet data with a relatively high similarity to evaluation target packet data from a plurality of pieces of normal packet data on a basis of a natural language processing model; and
detecting whether or not the evaluation target packet data is abnormal on the basis of an anomaly score calculated by comparing a predetermined number of pieces of the similar normal packet data extracted in the extracting with the evaluation target packet data.

8. A non-transitory computer-readable recording medium storing therein a detection program that causes a computer to execute a process comprising:
extracting a predetermined number of pieces of similar normal packet data with a relatively high similarity to evaluation target packet data from a plurality of pieces of normal packet data on a basis of a natural language processing model; and
detecting whether or not the evaluation target packet data is abnormal on the basis of an anomaly score calculated by comparing a predetermined number of pieces of the similar normal packet data extracted in the extracting with the evaluation target packet data.
